(19) United States
(12) Patent Application Publication
(10) Pub. No.: US 2014/0352934 A1
(43) Pub. Date: Dec. 4, 2014

(54) PLATE HEAT EXCHANGER

(71) Applicant: HAMILTON SUNDSTRAND CORPORATION, Windsor Locks, CT (US)

(72) Inventors: Michael R. Barone, Amston, CT (US); Richard Rusich, Ellington, CT (US)

(73) Assignee: HAMILTON SUNDSTRAND CORPORATION, Windsor Locks, CT (US)

(21) Appl. No.: 13/903,582

(22) Filed: May 28, 2013

(51) Int. Cl. F28F 3/08; B23P 15/26; F28D 9/00

(52) U.S. Cl. CPC F28F 3/08; F28D 9/0062; B23P 15/26; F28F 2280/00
USPC 165/166; 29/890.043

(57) ABSTRACT

A plate heat exchanger includes a plurality of main plates having ridges and troughs to direct first and second flows of fluids across the main plates to exchange heat between the fluids while maintaining the first and second flows of fluids separate from each other. The heat exchanger also includes a first end plate including first and second inlets and first and second outlets. The first end plate includes a substantially flat inside surface configured to contact the ridges of a first main plate among the plurality of main plates and at least one slot formed in the substantially flat surface to provide a fluid communication of the first fluid flow between the inlet and a cavity formed by the first end plate and the first main plate.

### BACKGROUND OF THE INVENTION

Embodiments of the invention relate to a plate heat exchanger, and in particular to end plates of plate heat exchanger.

Plate heat exchangers are widely used in the commercial industry as a means of exchanging energy between two liquids. The construction consists of a series of main plates having ribbed patterns on their surfaces and stacked one on top of the other. This arrangement forms channels between the plates through which the two liquids pass. As the two liquids enter their respective inlet ports they are independently directed to flow into alternating fin channels which permits heat to transfer from one liquid to the other. In order to maintain separation of the two liquids within the ports, the main plates incorporate local depressions in the port areas which alternately block off the flow passage from the port to the fin channels. In this way each port is hydraulically connected to every other fin channel. Each plate is coated with a braze filler metal. The entire heat exchanger assembly is placed in a furnace where the filler metal is melted creating a metallurgical bonds between the plates and forming a fluid seal.

Plate heat exchangers include top and bottom seal plates and top and bottom outer plates on outward-facing surfaces of the top and bottom seal plates, respectively. The top seal plate has a smooth surface and the bottom seal plate has a ribbed inward-facing surface (toward a center of the plate heat exchanger) and a smooth outward-facing surface (away from the center of the plate heat exchanger). The top and bottom seal plates form the outer pressure vessel of the heat exchanger. Typically, individual seals or seal slugs must be installed to block off the flow passage from an inlet port to a flow channel in the plate heat exchanger. The seal slugs are positioned around the inlets between the top seal plate and an adjacent main plate. However, the position of the individual seal slugs can shift during assembly and therefore are prone to cause fluid leakage of the heat exchanger.

In addition, ambient air can migrate into the space between the top seal plate and top outer plate. While the fluids passing through the heat exchanger may exhibit low freezing points that allow their temperatures to fall below 0° F. (−17.78° C.) without affecting the liquid states of the fluids, moisture within the ambient air freezes at 32° F.(0° C.). Consequently, the moisture in trapped between the top seal plate and the top outer plate may expand and crack the heat exchanger plates resulting in fluid leakage.

In addition, the draft angle of flanges of the main plates are chosen to ensure a proper braze seal between each main plate. The raised ribbed areas (herringbones) control the distance of separation between adjacent plates. A top seal plate having a flange with a same draft angle as an adjacent main plate may result in a poor fit, since the top seal plate does not include ridges. The poor fit may result in poor braze adhesion and fluid leakage.

The heat exchanger is subjected to stresses from the internal fluid pressures. The top plate and bottom plate provided support and stiffness to resist the internal pressure. The load emanating from the fluid pressure in the vicinity of the ports is commonly called a plug load. The area immediately surrounding the port areas is inherently subjected to high stresses due to the reduction of material (port holes) which must exist to allow fluid flow. Insufficient material around the port holes results in the inability of the heat exchanger to withstand low cycle fatigue resulting from pressure cycles of the liquids, ultimately leading to cracks and fluid leakage. However, the addition of excess material to compensate for the local high stresses would result in large weight penalties which cannot be tolerated in some applications, such as aerospace applications.

In addition, a position tolerance of the ports is subject to the ability to maintain a repeatable and consistent stack height of the main plates. Small variations in material thickness of the main plates (in the order of thousandths of an inch) will multiply by the number of main plates. An eighty-plate heat exchanger, for example can differ in stack height from unit to unit by 20 millimeters (mm) if each main plate had a variation of just 0.25 mm. When considering the additional position tolerances associated with other components of the heat exchanger, the resultant position tolerance of the ports can be 2.5 mm for example. This large variation from unit to unit is unacceptable for installations where precision is critical.

Mounting studs are conventionally welded to the thin top plate and bottom plate prior to furnace braze of the heat exchanger assembly. This requires time consuming welding and flush grinding of the underlying surfaces of the top and bottom plates adjacent to the studs to ensure a smooth uninterrupted surface against the adjacent main plates. The resultant strength of the stud retention is dramatically reduced. Also, the relatively thin top and bottom plates prevent sufficient thread engagement yielding a large variation in position tolerance of the studs. Additionally, the fluid fittings are historically welded to the weld stubs after furnace brazing. This requires time consuming welding and greater position tolerance of the final location of the fittings. The large variation from unit to unit is unacceptable for installations where precision is critical.

### BRIEF DESCRIPTION OF THE INVENTION

Embodiments of the present invention include a plate heat exchanger that includes a plurality of main plates having ridges and troughs to direct first and second flows of fluids across the main plates to exchange heat between the fluids while maintaining the first and second flows of fluids separate from each other. The heat exchanger also includes a first end plate including first and second inlets to provide the first and second flows to the plurality of main plates and first and second outlets to output the first and second flows from the plurality of main plates. The first end plate includes a substantially flat inside surface configured to contact the ridges of a first main plate among the plurality of main plates and at least one slot formed in the substantially flat surface to provide a fluid communication of the first fluid flow between the inlet and a cavity formed by the first end plate and the first main plate.

Embodiments of the invention further include a plate heat exchanger including a plurality of main plates having a ridged region including ridges and troughs to direct first and second flows of fluids across the main plates to exchange heat between the fluids while maintaining the first and second flows of fluids separate from each other. Each of the plurality of main plates further includes a flange extending from the ridged region at an oblique angle. The plate heat exchanger further includes a first end plate including first and second inlets to provide the first and second flows to the plurality of main plates and first and second outlets to output the first and second flows from the plurality of main plates. The first end plate includes a substantially flat main surface configured to contact the ridged region of a first main plate among the plurality of main plates and a flange surrounding the main surface and extending at an oblique angle with respect to the main surface. The flange of the first end plate has a draft angle less than a draft angle of the flange of the first main plate.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is an exploded view of a plate heat exchanger according to one embodiment;

FIG. 2A is a perspective view of a bottom end plate according to an embodiment;

FIG. 2B is a cut-away view of a portion of a bottom end plate according to an embodiment;

FIG. 3A is a top view of a top end plate according to one embodiment;

FIG. 3B is a cut-away view of the top end plate according to an embodiment;

FIG. 3C is a top view of a top end plate according to another embodiment;

FIG. 3D is a cut-away view of the top end plate according to an embodiment;

FIG. 3E is a cut-away view of the top end plate and a main plate according to an embodiment;

FIG. 4A illustrates a flange of a top end plate according to one embodiment;

FIG. 4B illustrates the flange of the top end plate in contact with a main plate according to one embodiment;

FIG. 4C illustrates a bottom end plate in contact with a main plate according to one embodiment;

FIG. 5A illustrates a perspective view of an outward-facing side of a top end plate according to one embodiment;

FIG. 5B illustrates a perspective view of an outward-facing side of a bottom end plate according to one embodiment;

FIG. 6 illustrates the mounting of a stud according to a conventional configuration;

FIG. 7 illustrates a stud-mounting portion of an end plate according to one embodiment of the invention;

FIG. 8 illustrates a cut-away view of a portion of a top end plate and a fluid fitting according to one embodiment;

FIG. 9 illustrates a block diagram of a system according to an embodiment of the invention; and

FIG. 10 illustrates a flow diagram of a method of instralling a plate heat exchanger according to an embodiment of the invention.

### DETAILED DESCRIPTION OF THE INVENTION

Conventional plate heat exchangers have structures that result in cracking in leaking due to misalignments of parts of the plate heat exchangers. Embodiments of the invention relate to a plate heat exchanger having end plates configured to improve the structural integrity of the plate heat exchanger, reducing cracking and leaks.

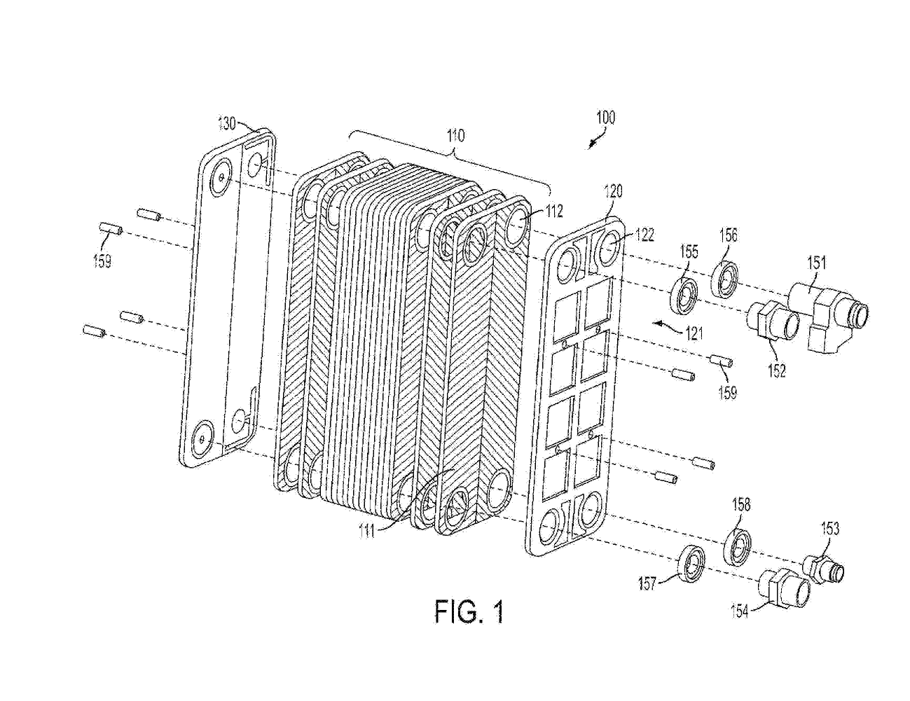

FIG. 1 is an exploded view of a plate heat exchanger 100 according to one embodiment. The plate heat exchanger 100 includes main plates 110 having ridged regions 111 and openings 112 corresponding to inlets and outlets of a fluid. The ridged regions 111 may have a herringbone or chevron pattern to increase a surface area of the main plate 110 contacted by the fluid and to generate turbulence in the fluid. The openings 112 of the main plates may be provided, alternatingly, with protrusions or recesses surrounding the openings 112 to alternate a fluid that enters a cavity between the main plates. For example, a first fluid may enter first, third and fifth cavities between the main plates, and a second fluid may enter second, fourth and sixth cavities. The fluids are maintained separate and exchange heat as they flow through the cavities.

The plate heat exchanger 100 includes a first end plate 120, also referred to herein as a top end plate 120 for purposes of description. The plate heat exchanger 100 also includes a second end plate 130, also referred to herein as a bottom end plate 130 for purposes of description. The top end plate 120 and bottom end plate 130 are positioned at opposite sides of the plurality of main plates 110. It is understood that although the terms “top” and “bottom” may be used for purposes of description, embodiments of the invention encompass a plate heat exchanger 110 having the first and second end plates 120 and 130 arranged with any spatial alignment relative to an earth plane.

The illustrated top end plate 120 includes openings 122 to receive fluid fittings 151, 152, 153 and 154. A first fluid may be input to the plate heat exchanger 100 via a fluid fitting 150 and output from the heat exchanger via a fluid fitting 152. Another fluid may be input to the plate heat exchanger 100 via the fluid fitting 153 and output from the plate heat exchanger 100 via the fluid fitting 154. Weld stubs 155, 156, 157 and 158 may also be provided between a wide portion of the fluid fittings 151, 152, 153 and 154 and the top end plate 120.

While particular shapes are used in FIG. 1 to represent the main plates 110, end plates 120 and 230, fittings 151, 152, 153 and 154, it is understood that these and other elements may have any desired shape. For example, the main plates 110 may have substantially rectangular, square, oval or any polygonal shape. In addition, the openings 112 and 122 may have a round shape, oval shape, square shape, or any other desired shape. Embodiments of the invention are not limited to the shapes illustrated, but include plate heat exchangers having any desired shape.

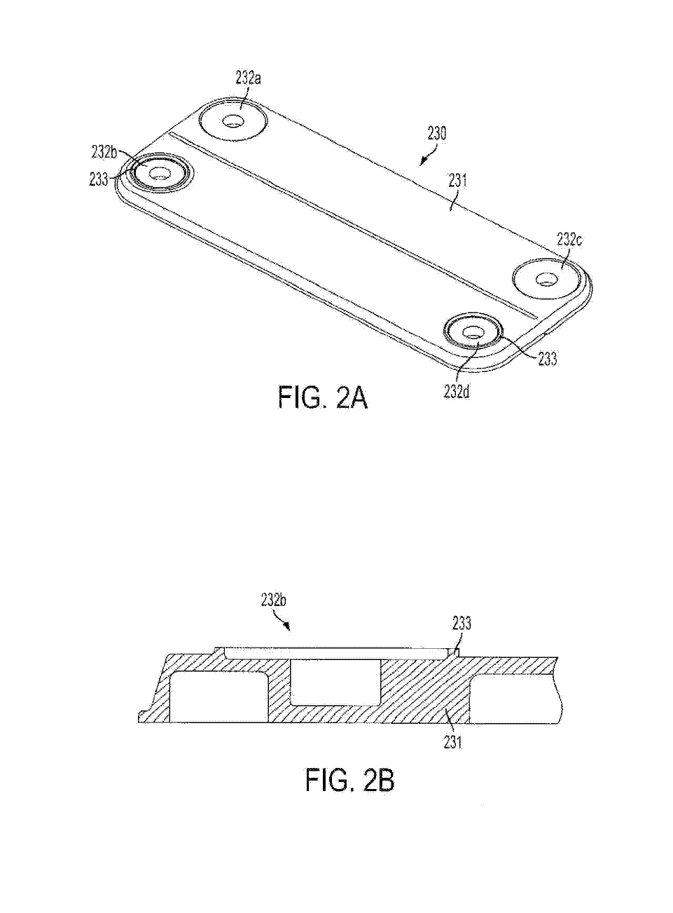

FIGS. 2A and 2B illustrate an integrated seal feature of a bottom end plate 230 according to one embodiment. The bottom end plate 230 may correspond to the bottom end plate 130 of FIG. 1. The bottom end plate 230 includes an inward-facing surface 231, inlet regions 232a and 232b and outlet regions 232c and 232d. The inlet region 232b and the outlet region 232d each include a raised portion 233, which may also be referred to as a protrusion 233, surrounding an area corresponding to an opening in an adjacent main plate to prevent a first flow fluid from flowing across the surface 230 from the inlet region 232b and from flowing out from the surface 230 via the outlet region 232d. In contrast, the inlet region 232a and outlet region 232c include no such raised portion 233 or protrusion. Consequently, fluid from the inlet region 232a flows over the inward-facing surface 231 and out through an opening in an adjacent main plate at the outlet region 232c.

While the raised portions 233 of the bottom end plate 230 are illustrated in FIGS. 2A and 2B, the top end plate includes similar raised portions. However, where the bottom plate 230 is closed-off or solid in each of the inlet regions 232a and 232b and outlet regions 232c and 232d, the inlet regions and outlet regions of the top plate are open to permit the flow of fluid through the top plate, such as by inserting fluid fittings or ports into the top plate. Accordingly, the raised portions on an inward-facing surface surrounding one inlet and one outlet of the top plate prevent fluid from flowing in a cavity between the top plate and an adjacent main plate. Conversely, the absence of the raised portions around another of the inlets and outlets permits fluid flow into and out from the cavity between the top plate and an adjacent main plate.

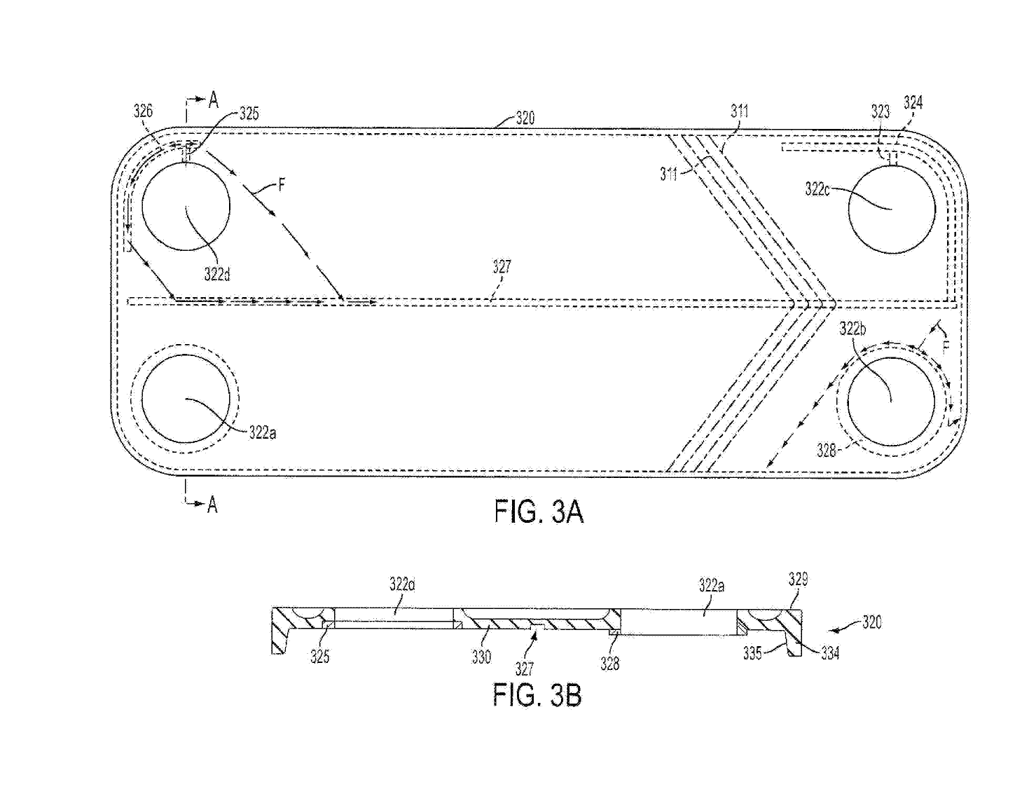

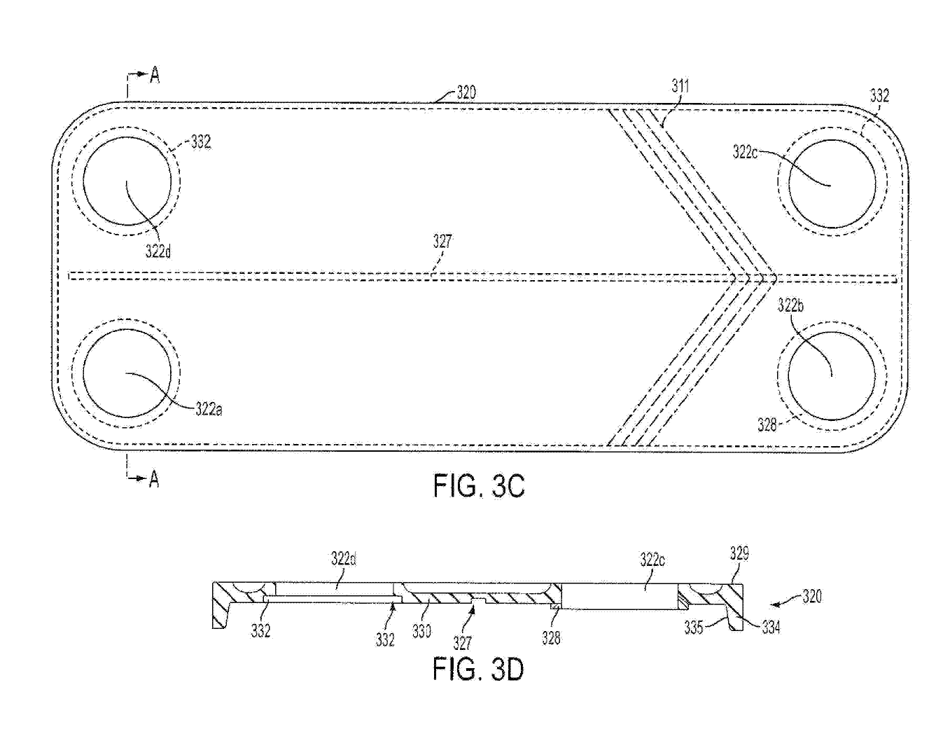

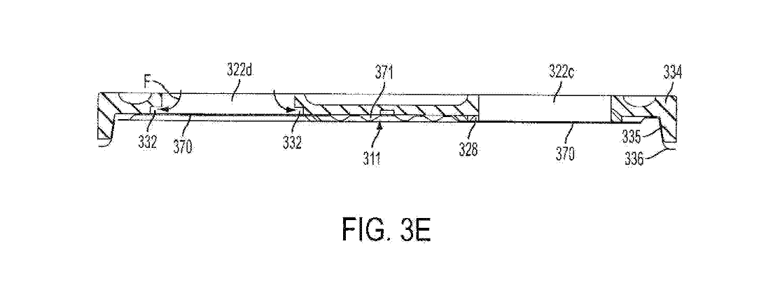

FIGS. 3A to 3E illustrate a top end plate 320 including flow-permitting slots according to one embodiment. The top end plate 320 may correspond to the top end plate 120 of FIG. 1. In FIGS. 3A and 3C, a view of the figures is of a top side 329 or outward-facing side 329 of the top end plate 320. Dashed lines represent features on an underside 330 of the top end plate 320 relative to the viewpoint of the figure (or in other words, features located on an inward-facing side 330). Dashed and dotted lines represent features on a main plate 370 (of FIG. 3E, for example) adjacent to the inward-facing side which are illustrated for purposes of description.

The top end plate 320 includes openings 322a, 322b, 322c and 322d corresponding to fluid inlets and outlets. For purposes of description, opening 322c will be described as a fluid inlet 322c and opening 322d will be described as a fluid outlet 322d. Depressions or slots 323, 324, 325 and 326 are formed in the inward-facing surface 330 of the top end plate 320. Slots 323 and 325 connect to, and extend radially from the inlet 322c and the outlet 322d, respectively. Slots 324 and 326 may be connected to the slots 323 and 325, and may partially surround the inlet 322c and the outlet 322d, respectively, along an outer edge of the inward-facing surface 330 of the top end plate 320.

A slot 327 may extend lengthwise along a center of the top end plate 320. In another embodiment, the slot 327 may be off-center. In FIG. 3, the location of the slot 327 is positioned to correspond to an apex of the herringbones or chevrons 311 of an adjacent main plate 370 (in FIG. 3E, for example). While only a few ridges 311 are illustrated in FIGS. 3A and 3C for purposes of description, it is understood that ridges 311 of the adjacent main plate extend over an entire surface of the adjacent main plate. When fluid F is input to the opening 322c from an external source and input to the opening 322d from a channel within the plate heat exchanger, fluid F from the openings 322c and 322d enters the slots 323 and 325, and from the slots 323 and 325, the fluid is transmitted to the slots 324 and 326. The slots 324 and 326 are in fluid communication with troughs located between the ridges 311 of the adjacent main plate. Accordingly, fluid F from the slots 324 and 326 flows through the troughs between the ridges 311 to the slot 327. From the slot 327, the fluid F may flow into any trough between ridges 311 of the main plate. Consequently, the fluid F may fill every cavity between the top end plate 320 and the adjacent main plate.

Referring to FIGS. 3B, 3D and 3E, in embodiments of the invention, the space between the top end plate 320 and the adjacent main plate is hermetically sealed, such as via a braze joint, from the ambient environment. This may be accomplished in one embodiment by incorporating a flange 334 to the top end plate 320 with the proper draft angle to ensure that the faying surface 335 between the top end plate flange 334 and the adjacent main plate flange 336 is brazed and entirely sealed from the ambient environment. This may reduce ambient moisture from entering this space and subsequently freeze and rupture the plates.

To ensure that the faying surfaces 335 have been properly brazed, the space between the plates, which may also be referred to as a dead zone 371, is pressurized with one of the fluids F entering the heat exchanger. Any voids in the braze will be immediately detected as an external leak during final test of the heat exchanger. A hermetically sealed joint may be detected by detecting no evidence of leakage. To achieve the pressurized dead zone 371, the port area, or the openings 322c and 322d and the dead zone may be hydraulically connected. The slots 323, 324, 325, 326 and 327 are strategically located to allow fluid pressure to enter each and every herringbone space between the top end plate 320 and the adjacent main plate 370. While only the top end plate 320 is illustrated in FIGS. 3A to 3E, similar slots may be formed in the bottom end plate, such as the bottom end plate 130 of FIG. 1, to similarly pressurize the dead zone 371 between the bottom end plate and an adjacent main plate.

A raised portion 328 or protrusion 328 surrounds the opening 322a to prevent fluid from the opening 322a from entering the dead zone 371 between the top end plate 320 and an adjacent main plate 370. The raised portion 328 is illustrated with dashed lines in FIGS. 3A and 3C.

While FIGS. 3A and 3B illustrate slots 323, 324, 325 and 326, any configuration of slots may be used that allow for the fluid F from at least one of the openings 322a, 322b, 322c and 322d to fill the dead zone between the top end plate 320 and an adjacent main plate 370. For example, FIGS. 3C and 3D illustrate an embodiment in which a slot 332 or depression 332 is formed to entirely or substantially surround the openings 322c and 322d. The slot 322 may be in fluid communication with the troughs between ridges 311 of the adjacent main plate 370 (of FIG. 3E), such that fluid flows from the openings 322c and 322d to the slots 332, to the troughs between the ridges 311, to the slot 327, and from the slot 327 to every trough to fill every space within the dead zone 371.

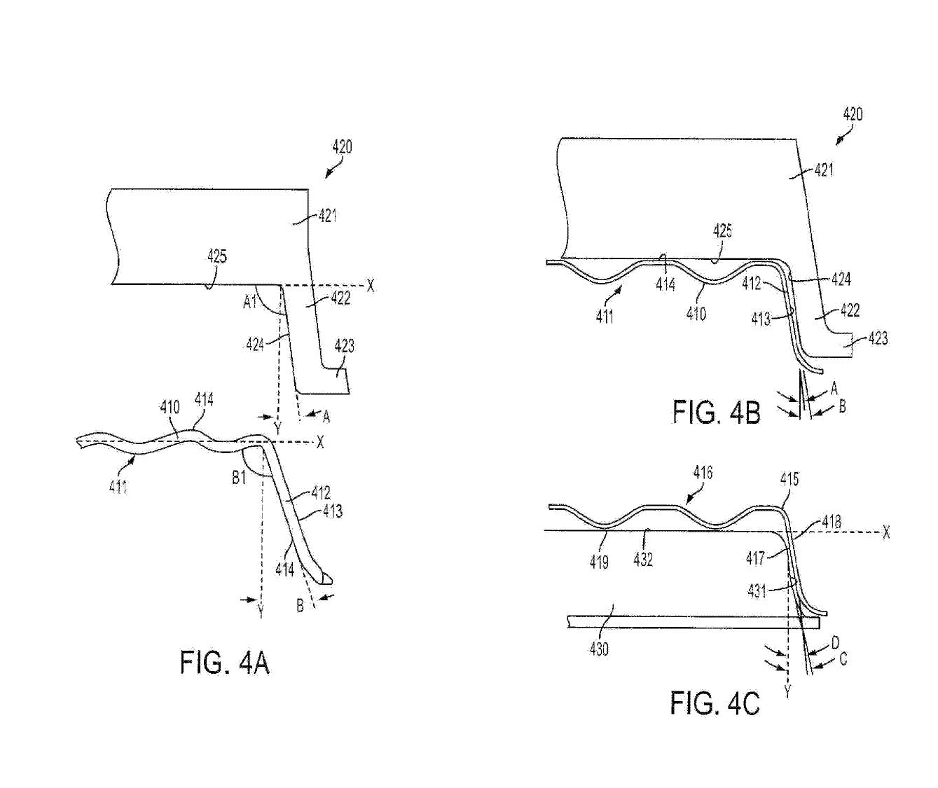

FIGS. 4A to 4C illustrate faying surfaces of end plates according to embodiments of the present invention. The top end plate 420 may correspond to the top end plate 120 of FIG. 1, and the bottom end plate 430 may correspond to the bottom end plate 130 of FIG. 1.

FIG. 4A illustrates a top end plate 420 including a body 421 and a flange 422 extending downward and away from the body 421. When an inward-facing surface 425 of the top end plate 420 defines a first axis X, which may also be referred to for purposes of description as horizontal axis X, a second axis Y, also referred to as a vertical axis Y, is perpendicular to the horizontal axis X. The flange 422 may extend outward from the body at an acute angle A relative to the vertical axis Y. The inside surface 424 of the flange 422, which is also referred to as the faying surface 424 may be at an obtuse angle A1 relative to the inward-facing surface 425. The flange 422 may also include a protrusion 423 at its end that bends outward toward the horizontal axis X.

FIG. 4A also illustrates a main plate 410, which may correspond to one of the main plates 110 of FIG. 1. As illustrated in FIG. 4B, the main plate 410 is adjacent to the top end plate 420 and is configured to be bonded to the top end plate 420 on an outside flange surface 413 and ridge peaks 414, such as by brazing. The main plate 410 includes ridges 411 having peaks 414 and a flange 412 extending downward from the ridges 414. A line passing through a substantially center portion of each of the ridges 411 defines the horizontal axis X. The flange 412 extends downward from the ridges 411 to be at an acute angle B relative to the vertical axis Y, and at an obtuse angle B1 relative to the horizontal axis X, as measured along an inside arc from an inside surface 414 of the flange 412 to a portion of the axis X along the ridges 411. In the present specification and claims, the angles A and B are also referred to as draft angles A and B.

In one embodiment, the draft angle A is different than the draft angle B. In particular, the draft angle A may be less than the draft angle B, and the angle A1 may be less than the angle B1. As illustrated in FIG. 4B, the top end plate 420 is configured to be mounted onto the main plate 410, such that the inward-facing surface 425 contacts the peaks 414 of the ridges 411 of the main plate 410, while at the same time the inward-facing surface 424 of the flange 422 contacts the outer surface 413 of the flange 412. Since the draft angles A and B of the top end plate 420 and the main plate 410 are dissimilar, a “line contact” is formed around the periphery of the two flanges 422 and 412. When a braze melts during a brazing operation, capillary action forces the braze to “wick up” along the entire flange faying surfaces 413 and 424, thus providing a highly reliable braze joint and hermetic seal. In other words, since the draft angles A and B of the top end plate 420 and the main plate 410 are dissimilar, the flange 422 does not contact the flange 412 along an entire length of the flange 412, but only along a narrow region that defines the line contact around an entire circumference of the flange 412.

A similar feature is provided for the bottom end plate 430, as illustrated in FIG. 4C. The bottom end plate 430 includes an upper surface 432, or an inward-facing surface 432, which defines the horizontal axis X. The vertical axis Y is perpendicular to the horizontal axis X. An outer side or surface 431 of the bottom end plate 430 has a draft angle C. A main plate 415 adjacent to the bottom end plate 430 has ridges 416 with peaks 419 contacting the inside-facing surface 432 of the bottom end plate 430. The main plate 415 includes a flange 418 extending over the outer surface 431 of the bottom end plate 430 and having a draft angle D. In embodiments of the present invention, the draft angle C is greater than the draft angle D. As discussed above, since the draft angles C and D of the bottom end plate 430 and the main plate 415 are dissimilar, a “line contact” is formed around the periphery of the outer surface 431 and the inner surface 417 of the flange 418. When a braze melts during a brazing operation, capillary action forces the braze to “wick up” along the entire flange faying surfaces 431 and 417, thus providing a highly reliable braze joint and hermetic seal.

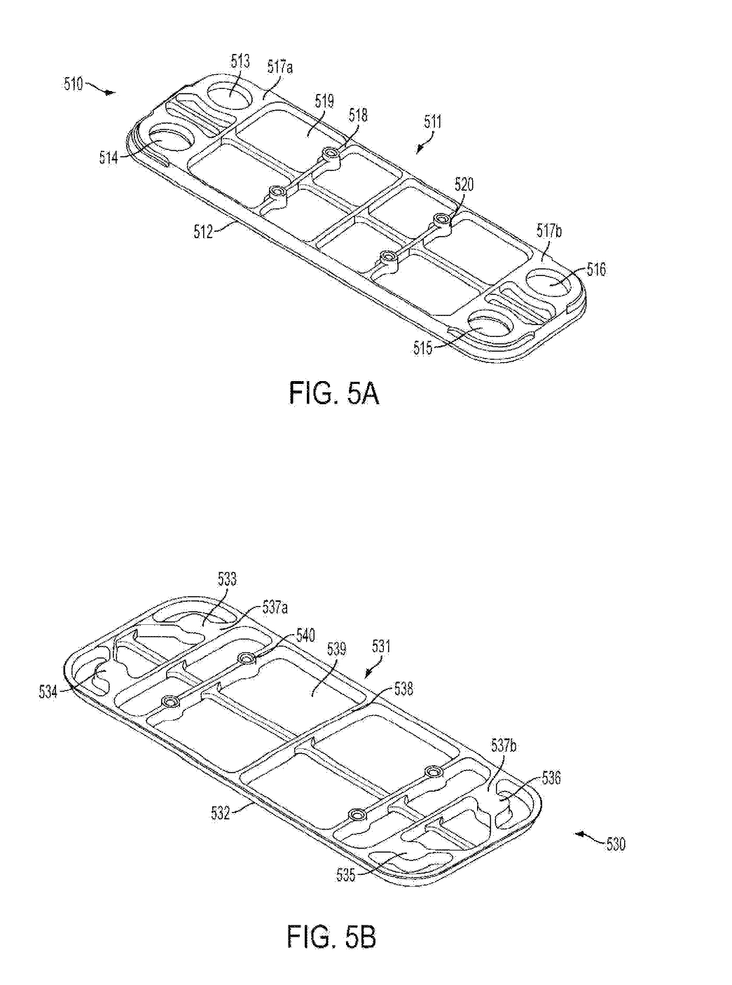

FIGS. 5A and 5B illustrate strengthening structures of a top end plate 510 and a bottom end plate 530 according to embodiments of the invention. The top end plate 510 and bottom end plate 530 may correspond to the top end plate 120 and bottom end plate 130, respectively, of FIG. 1, for example.

Referring to FIG. 5A, the top end plate 520 includes an outward-facing surface 511 and an inward-facing surface 512 opposite the outward-facing surface 511. The top end plate 520 is made up of a thin layer 519, resulting in a top end plate 520 having a lighter weight. The top end plate 520 also includes thick regions 517a and 517b around the openings 513, 514, 515 and 516. The thick regions 517a and 517b are situated in areas that have been predetermined to be subject to higher levels of stress during operation of the plate heat exchanger. The top end plate 520 also includes ribs 518 extending width-wise across the outward-facing surface 511 to provide additional strength. Bosses 520 may be formed along the ribs 518 for receiving mounting studs.

Referring to FIG. 5B the bottom end plate 530 includes an outward-facing surface 531 and an inward-facing surface 532 opposite the outward-facing surface 531. The bottom end plate 530 is made up of a thin layer 539, resulting in a bottom end plate 530 having a lighter weight. The bottom end plate 530 also includes thick regions 537a and 537b around the port regions 533, 534, 535 and 536. The thick regions 537a and 537b are situated in areas that have been predetermined to be subject to higher levels of stress during operation of the plate heat exchanger. The bottom end plate 530 also includes ribs 538 extending width-wise across the outward-facing surface 511 to provide additional strength. Bosses 540 may be formed along the ribs 538 for receiving mounting studs.

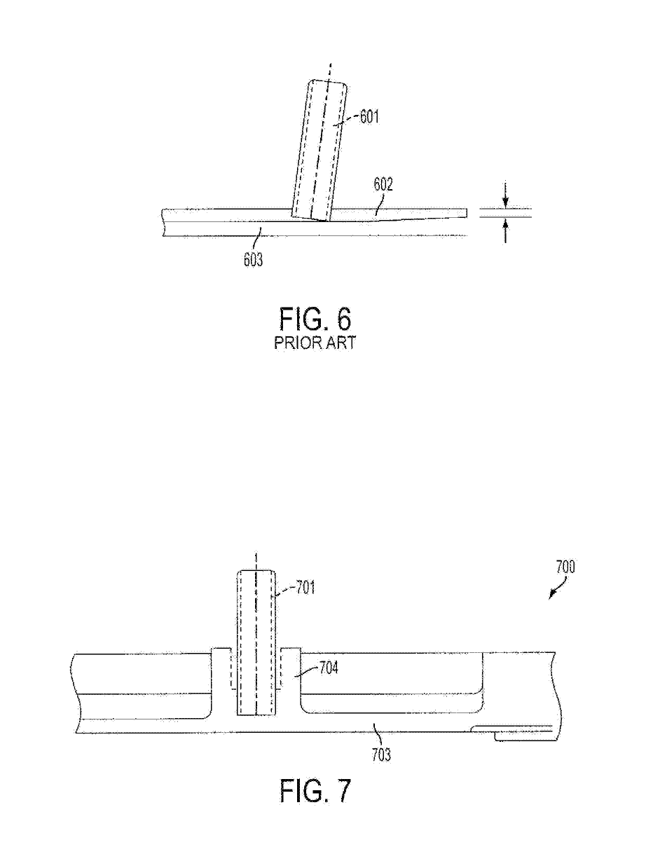

FIG. 6 illustrates the mounting of a stud 601 according to a conventional configuration, and FIG. 7 illustrates a stud-mounting portion of an end plate 700 according to one embodiment of the invention. The end plate 700 may correspond to the top end plate 120 or bottom end plate 130 of FIG. 1, for example. Referring to FIG. 6, in conventional plate heat exchangers, a stud 601 was inserted into a hole in an outer plate 601 and was brazed or welded to a seal plate 603. However, in conventional plate heat exchangers, shifting of one of the plates 602 or 603 prior to brazing, during brazing or after brazing may result in a bending or tilting of the stud 601. Referring to FIG. 7, in embodiments of the invention, a boss 704 or protrusion 704 is configured to protrude from a base 703 of an end plate 700. The protrusion 704 has a shape configured to receive the stud 701, such as a round inner shape of a same size as a round outer shape of the stud 701. The base 703 of the end plate 700 is the base of the receptacle defined by the protrusion 704. Since the protrusion 704 extends outward from the base 703 of the end plate 700, the stud 701 does not shift, bend or tilt in the event that the end plate 700 shifts.

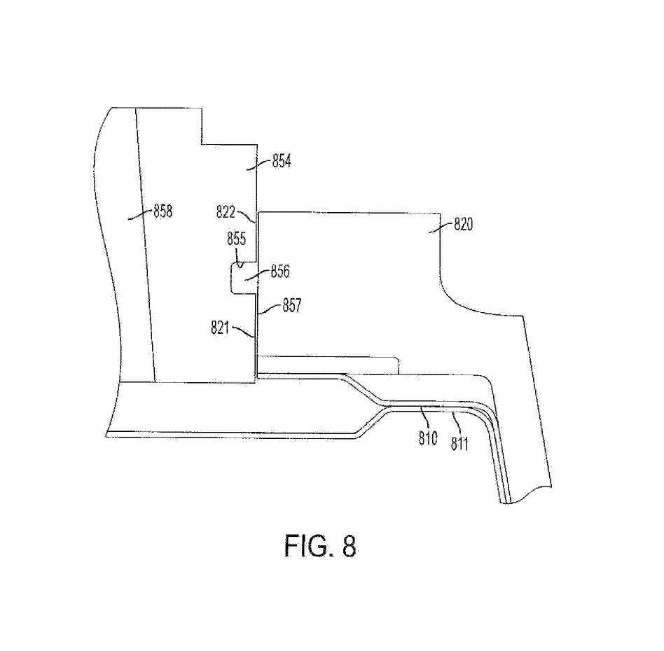

FIG. 8 illustrates a cut-away view of a portion of a top end plate 820 and a fluid fitting 854 according to one embodiment. The top end plate 820 may correspond to the top end plate 120 of FIG. 1, and the fluid fitting 854 may correspond to one of the fluid fittings 151, 152, 153 or 154 of FIG. 1, for example.

The top end plate 820 includes a port defined by an inner diameter surface made up of a lower portion 821, also referred to as a pilot region 821 and an upper portion 822, also referred to as a braze region 822. The top end plate 820 may be configured to be attached to the main plate 810, and the main plate 810 may be configured to be attached to the main plate 811. The inner diameter surface of the top end plate 820 may be configured to receive the fluid fitting 854 having an outer diameter surface 857. A recess 856 is formed in the outer diameter surface 857 of the fluid fitting 854, the recess 856 defined by recess walls 855. The fluid fitting 854 may also include a fluid channel 858.

In embodiments of the invention, the recess 856 is formed to have a pre-defined size such that a predetermined amount of braze material may be provided in the recess 856. The pilot region 821 has a diameter smaller than the braze region 822, such that the pilot region 821 tightly or closely contacts the outer diameter surface 857 while the braze region 822 defines a gap between a surface of the braze region 822 and the outer diameter surface 857. The thickness of the braze material between the outer diameter surface 857 and the braze region 822 may be pre-determined and controlled based on controlling the diameter of the braze region 822, thereby maintaining the strength of a braze joint.

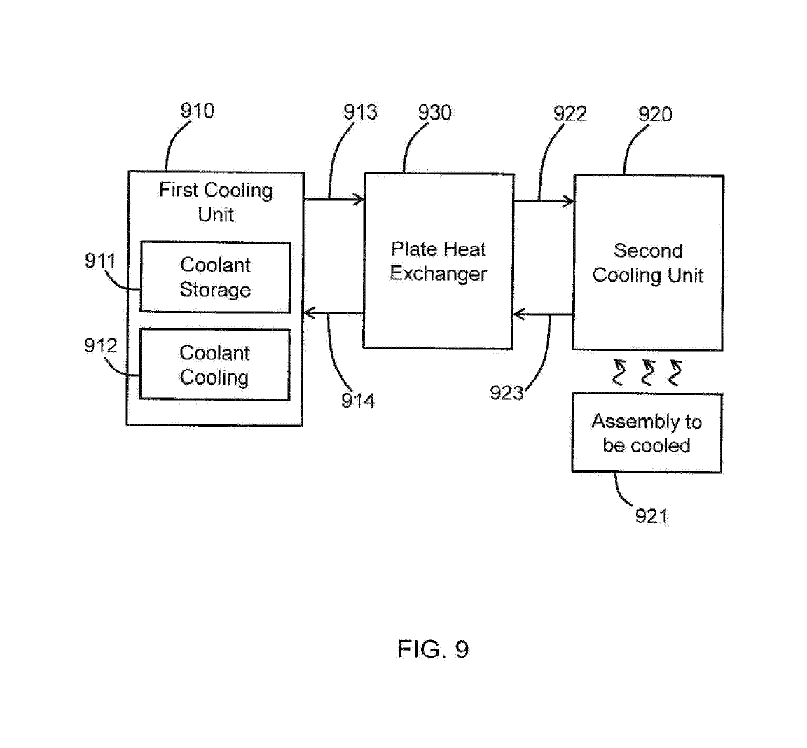

FIG. 9 illustrates a system 900 according to an embodiment of the invention. The system 900 includes a first cooling unit 910, a second cooling unit 920 and a plate heat exchanger 930. The plate heat exchanger 930 corresponds to the plate heat exchanger 100 of FIG. 1. The first cooling unit 910 may include a coolant storage system 911 or coolant cooling system 912 to cool coolant. The coolant is transmitted to the plate heat exchanger 930 via a tube 913 and is received from the plate heat exchanger 930 via a tube 914. The second cooling unit 920 is configured to cool an assembly 921 with coolant, such as by convection. The coolant exits the plate heat exchanger 930 at a relatively cold temperature via the tube 922, absorbs heat from the assembly 921, and enters the heat exchanger 930 via the tube 923 at a relatively warm temperature. The assembly 921 may be any apparatus, system or assembly, including electrical and mechanical components or systems.

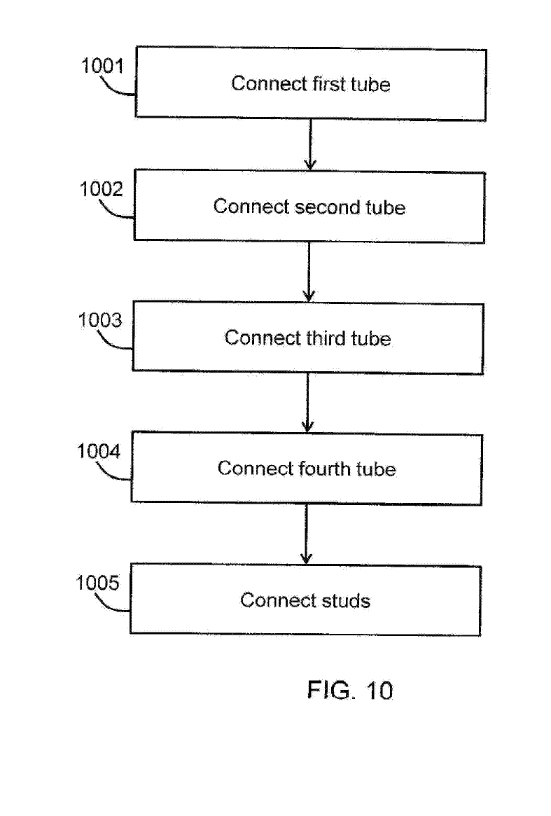

FIG. 10 illustrates a flow diagram of a method of installing a plate heat exchanger according to an embodiment of the invention. In blocks 1001, 1002, 1003 and 1004 first, second, third and fourth tubes are connected to the plate heat exchanger. The tubes are configured to transmit and receive fluids to and from the plate heat exchanger.

In block 1005, the studs of the plate heat exchanger are mounted to a stud mount. In one embodiment, the stud mount includes one or more holes or recesses into which the studs are inserted.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A plate heat exchanger, comprising:
a plurality of main plates having ridges and troughs to direct first and second flows of fluids across the main plates to exchange heat between the fluids while maintaining the first and second flows of fluids separate from each other;
a first end plate including first and second inlets to provide the first and second flows to the plurality of main plates and first and second outlets to output the first and second flows from the plurality of main plates, the first end plate including a substantially flat inside surface configured to contact the ridges of a first main plate among the plurality of main plates and at least one first slot formed in the substantially flat surface to provide a fluid communication of the first fluid flow between the inlet and a first cavity formed by the first end plate and the first main plate;
a second end plate on an opposite side of the plurality of main plates from the first end plate, the second end plate including a substantially flat inside surface configured to contact the ridges of a second main plate among the plurality of main plates and at least one second slot formed in the substantially flat surface to provide a fluid communication of one of the first fluid flow and the second fluid flow between one of the first and second inlets and a second cavity formed by the second end plate and the second main plate,
wherein the first main plain includes a ridged portion and a flange surrounding the ridged portion and extending outward from the ridged portion to have a draft angle that is an acute angle,
the first end plate comprises a body having an inside surface configured to contact the ridges of the ridged portion of the first main plate and a flange surrounding the main body, an inside surface of the flange of the first end plate configured to contact an outer surface of the flange of the first main plate, and a draft angle of the first end plate being less than the draft angle of the first main plate,
the first end plate includes at least one thin region and at least one thick region, the at least one thick region located in a region identified as being subject to a greater stress than the at least one thin region when the plate heat exchanger is in operation, the at least one thick region including regions surrounding the first and second inlets and first and second outlets at ends of the first end plate, and
wherein the plurality of main plates are sealed together and to the first and second end plates by brazing.

2. The plate heat exchanger of claim 1, wherein the first and second end plates are machined end plates.

3. The plate heat exchanger of claim 1, wherein the at least one slot includes a first slot extending radially from the first inlet, a second slot having a substantially circumferential shape around a portion of the first inlet and connected to the first slot, and a third slot extending lengthwise along a center of the first end plate.

4. The plate heat exchanger of claim 1, wherein the at least one slot includes a first slot extending circumferentially around an entire circumference of the first inlet, and a second slot extending lengthwise along a center of the first end plate.

5. The plate heat exchanger of claim 1, wherein the first fluid is pressurized in the cavity formed by the first end plate and the first main plate.

6. The plate heat exchanger of claim 1, wherein the first main plate includes a plurality of ridges separated by a plurality of troughs, the plurality of troughs and ridges forming a chevron pattern,
the at least one slot includes a first slot adjacent to the first inlet and a second slot extending lengthwise along a center of the first end plate at an apex of the chevron pattern, and
the first slot is in fluid communication with at least one trough between adjacent ridges of the first main plate, the at least one trough is in fluid communication with the second slot, and the second slot is in fluid communication with each other trough of the plurality of troughs.

7. The plate heat exchanger of claim 1, further comprising a protrusion surrounding the first inlet on an inside surface of the first end plate, the protrusion configured to contact the first main plate to form a fluid-tight seal with the first main plate.

8. The plate heat exchanger of claim 1, wherein the second main plate includes a ridged portion and a flange surrounding the ridged portion and extending outward from the ridged portion to have a draft angle that is an acute angle, and the second end plate has a first outer side configured to contact the ridged portion of the second main plate and a second outer side surrounding the first outer side and having a draft angle that is an acute angle, the second outer side configured to contact an inner side of the flange of the second main plate, the draft angle of the second outer side being greater than the draft angle of the second main plate.

9. The plate heat exchanger of claim 1, further comprising ribs extending width-wise across the first end plate.

10. The plate heat exchanger of claim 1, wherein the first end plate includes at least one receptacle on an outward-facing surface opposite the inside surface, the at least one receptacle comprising a base and a protrusion having a shape configured to receive and surround a mounting stud, such that sides of the mounting stud contact sides of the protrusion while an end of the mounting stud faces the base of the receptacle.

11. The plate heat exchanger of claim 1, further comprising a fluid fitting configured to fit into at least one of the first inlet and the first outlet to provide a flow of fluid through the fluid fitting into or out from the plurality of main plates, the fluid fitting including a recess in a surface adjacent to an inner diameter surface of the at least one of the first inlet and the first outlet.

12. A cooling system, comprising:
a first cooling assembly configured to cool an apparatus with a first cooling fluid; and
a plate heat exchanger configured to receive the first cooling fluid and to cause the first cooling fluid and a second cooling fluid from a second cooling assembly to flow in adjacent channels to exchange heat from the first cooling fluid to the second cooling fluid, the plate heat exchanger comprising:
a plurality of main plates having ridges and troughs to direct first and second flows of the first and second cooling fluids, respectively, across the main plates to exchange heat between the first and second cooling fluids while maintaining the first and second cooling fluids separate from each other;
a first end plate including first and second inlets to provide the first and second flows to the plurality of main plates and first and second outlets to output the first and second flows from the plurality of main plates, the first end plate including a substantially flat inside surface configured to contact the ridges of a first main plate among the plurality of main plates and at least one first slot formed in the substantially flat surface to provide a fluid communication of the first fluid flow between the inlet and a first cavity formed by the first end plate and the first main plate;
a second end plate on an opposite side of the plurality of main plates from the first end plate, the second end plate including a substantially flat inside surface configured to contact the ridges of a second main plate among the plurality of main plates and at least one second slot formed in the substantially flat surface to provide a fluid communication of one of the first flow and the second flow between one of the first and second inlets and a second cavity formed by the second end plate and the second main plate,
wherein the first main plain includes a ridged portion and a flange surrounding the ridged portion and extending outward from the ridged portion to have a draft angle that is an acute angle,
the first end plate comprises a body having an inside surface configured to contact the ridges of the ridged portion of the first main plate and a flange surrounding the main body, an inside surface of the flange of the first end plate configured to contact an outer surface of the flange of the first main plate, and a draft angle of the first end plate being less than the draft angle of the first main plate,
the first end plate includes at least one thin region and at least one thick region, the at least one thick region located in a region identified as being subject to a greater stress than the at least one thin region when the plate heat exchanger is in operation, the at least one thick region including regions surrounding the first and second inlets and first and second outlets at ends of the first end plate, and
wherein the plurality of main plates are sealed together and to the first and second end plates by brazing.

13. A method of installing a plate heat exchanger, the method comprising:
attaching a first tube to a first inlet of the plate heat exchanger to form a fluid-tight seal, the first tube configured to provide a first fluid flow of a first fluid to the plate heat exchanger;
attaching a second tube to a second inlet of the plate heat exchanger to form a fluid-tight seal, the second tube configured to provide a second fluid flow of a second fluid to the plate heat exchanger;
attaching a third tube to a first outlet of the plate heat exchanger to form a fluid-tight seal, the third tube configured to receive the first fluid flow of the first fluid from the plate heat exchanger; and
attaching a fourth tube to a second outlet of the plate heat exchanger to form a fluid-tight seal, the fourth tube configured to receive the second fluid flow of the first fluid from the plate heat exchanger,
wherein the plate heat exchanger comprises:
a plurality of main plates having ridges and troughs to direct the first and second fluid flows across the main plates to exchange heat between the first and second fluids while maintaining the first and second fluid flows separate from each other;
a first end plate including the first and second inlets to provide the first and second fluid flows to the plurality of main plates and the first and second outlets to output the first and second fluid flows from the plurality of main plates, the first end plate including a substantially flat inside surface configured to contact the ridges of a first main plate among the plurality of main plates and at least one first slot formed in the substantially flat surface to provide a fluid communication of the first fluid flow between the inlet and a first cavity formed by the first end plate and the first main plate;
a second end plate on an opposite side of the plurality of main plates from the first end plate, the second end plate including a substantially flat inside surface configured to contact the ridges of a second main plate among the plurality of main plates and at least one second slot formed in the substantially flat surface to provide a fluid communication of one of the first fluid flow and the second fluid flow between one of the first and second inlets and a second cavity formed by the second end plate and the second main plate,
wherein the first main plain includes a ridged portion and a flange surrounding the ridged portion and extending outward from the ridged portion to have a draft angle that is an acute angle,
the first end plate comprises a body having an inside surface configured to contact the ridges of the ridged portion of the first main plate and a flange surrounding the main body, an inside surface of the flange of the first end plate configured to contact an outer surface of the flange of the first main plate, and a draft angle of the first end plate being less than the draft angle of the first main plate,
the first end plate includes at least one thin region and at least one thick region, the at least one thick region located in a region identified as being subject to a greater stress than the at least one thin region when the plate heat exchanger is in operation, the at least one thick region including regions surrounding the first and second inlets and first and second outlets at ends of the first end plate, and
wherein the plurality of main plates are sealed together and to the first and second end plates by brazing.

14. The method of claim 13, further comprising:
providing the first fluid flow into the first inlet and receiving the first fluid flow out from the first outlet; and
providing the second fluid flow into the second inlet and receiving the second fluid flow out from the second outlet.
